(19) United States
(12) Patent Application Publication
(10) Pub. No.: US 2007/0138381 A1
(43) Pub. Date: Jun. 21, 2007

(54) Optical encoder system

(76) Inventor: John T. Meschko, Sagle, ID (US)

Correspondence Address: WELLS ST. JOHN P.S., 601 W. FIRST AVENUE, SUITE 1300, SPOKANE, WA, 99201, US

(21) Appl. No.: 11/303,736

(22) Filed: Dec. 16, 2005

(51) Int. Cl. G01D 5/34

(52) U.S. Cl. 250/231.13

(57) ABSTRACT

An optical encoder is disclosed, the optical encoder generally including an encoder framework, a light source for emitting light, said light source mounted to the encoder framework, a light detector attached to the encoder framework and disposed to receive light emitted from the light source, a light interruption screen with opaque regions and transparent regions, the opaque regions and transparent regions being movably positioned between the light source and the light detector such that movement of the opaque regions interrupts the light emitted from the light source to the light detector, and further wherein the light source is mounted to the encoder framework transverse such that the light is emitted at an angle from the axis of the rotating member.

### CROSS REFERENCE TO RELATED APPLICATION There are no related patent applications.

### TECHNICAL FIELD

This invention pertains to an optical encoder system for sensing motion and more particularly to an optical encoder system that may sense and/or track angular position, linear position, velocity and direction.

### BACKGROUND OF THE INVENTION

An optical encoder generally senses motion by tracking the angular or linear position of an object, and its velocity and direction. Optical encoders generally track mechanical motion through optical means, such as the transmission of a light beam or an optical signal. The basic components of optical encoders generally include a light source such as a light emitting diode (LED), a light detector or sensor and an intermediate component which has opaque areas and transparent areas which either allow or block the light from reaching the sensor. The transparent areas allow part or all of the light to pass through to the sensor whereas the opaque areas block part or all of the light.

The linear or radial movement of the intermediate member, the screen or disk with the opaque and transparent sections, creates intermittent transmission of the light beam from the light source or light emitter to the sensor, and it is the intermittent nature and timing of the transmission which is measured and correlated to mechanical movement such as the revolutions per minute of a shaft, or the linear movement of a component. This may also be referred to as a light interruption screen. A linear encoder application may be for limited length items, such as an X-Y table, machining tables, and others.

The term “encoder” may include any one of a number of different types of encoders in which light is transmitted through an intermediate member such as a moveable screen, disk or scale, as will be appreciated by those of ordinary skill in the art. Movement of the screen, disk or scale with light blocking and light transmission areas (opaque and transparent) affects the signal or light reception and the data “sensed”. The signal reception and data sensed generally relate to the intensity, duration, or both intensity and duration, of the light beam with respect to the blocked and unblocked areas. Encoders which allow light to pass through the intermediate member (such as a rotating screen or light interruption screen for example), may be referred to as transmissive type encoders wherein the light emitter or source of light is on the opposite side of the light interruption screen as the light sensor or detector; whereas reflective encoders may also refer to encoder applications wherein the light and the sensor are on the same side of the light interruption screen and the light reflects back off the disk.

In some optical encoder system applications, an additional intermediate member sometimes referred to as a reticle or mask, is positioned in the light path between the source of light and the light detector or light sensor. Reticles are known by those of ordinary skill in the art and are used in some encoder designs positioned in the light path between the light emitter and the light sensor. Reticles may contain a pattern of light transmission areas and light blocking areas to improve the optical performance of the encoder. In some applications the reticule may be either omitted or incorporated into the design as part of the geometry of the light detector. As will be appreciated by those of ordinary skill in the art, the signals received, as well as the timing of the signals, may provide data for any one of a number of different uses.

In applications in which the mechanical movement of rotating shaft is desired to be monitored or sensed, a rotary optical encoder, the fundamental components may include a screen or disk with areas of transparent or unblocked sections and opaque or blocked sections, operatively connected to, or integral with, a support fitting which then facilitates the operational attachment of the rotating shaft to the screen.

A light detecting sensor is provided in encoder systems, along with a light source such as light emitting diode (LED). The light detector and/or the light emitter may be mounted to a base member such as a printed circuit board for support and control, although it is more common in for the light detector to be so mounted. The light detector and light source may be mounted to a base framework to support or dispose the two components relative to one another.

It will be appreciated and known by those of ordinary skill in the art that the light sensors may be any one or more of a number of different sensors available for the specific application, with no one in particular being required to practice the invention. For example one embodiment may utilize one photo diode whereas another utilizes two or more. In some semiconductor examples, the light or photons in the light hit the photo diode, which causes an electrical signal to be generated.

In prior art transmissive rotary encoders, the light detector and light source usually face each other from opposite sides of the movable screen or disk. The detectors are generally aligned in position with respect to the screen for proper encoder operation. In rotary encoders for. rotating shafts for example, the prior art applications attempt to position the light emitter so that the light beam emitted is substantially parallel to the axis of rotation, which is also normally perpendicular to the surface of the photo detector and/or screen. The light generally passes through the rotating screen or disc approximately ninety degrees to the screen or disc surface. In some cases the light source may be moved or tipped slightly during the calibration of the encoder, but this is typically less than ten degrees and done to compensate for imperfections in the light source or slight misalignments in the other optical components.

Linear encoders have generally the same components, however the linear scale takes the place of the rotary screen and the fittings are adapted for linear motion instead of rotary or rotating motion and measurement. As the disk or scale moves over the light sensor, it detects light that passes through the unblocked or transparent sections and will not detect light that hits the opaque or blocked sections of the disk or scale. Alternating states of opaque versus transparent, trigger electrical output signals that may be used to determine the position, speed and direction of the linear or rotary optical encoder.

As will be appreciated by those of ordinary skill in the art, precise alignment between the source of the light beam, the detector and a disk or scale may be important to the operation and accuracy of the optical encoder.

Due to the nature of optical encoders and the precision required of the installation, changes- to the configuration which ease the installation are desired by those of ordinary skill in the art. It is an object therefore of this invention to provide an improved optical encoder system, including one which may provide a more desirable configuration to simplify or ease the installation of the optical encoder system.

It is an object of one or more of the aspects of this invention to ease the establishment of precise alignment between the light detector, the light source and the disc or scale, to simplify and reduce the installation time necessary for the desired operation.

Other objects, features, and advantages of this invention will appear from the specification, claims and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings:

FIG. 1 is a perspective exploded view illustrating the basic components used in one embodiment of a rotary encoder contemplated by this invention;

FIG. 2 is a perspective exploded view illustrating the components of an encoder module which is configured in a prior art configuration wherein the source of the optical signal is generally aligned vertically;

FIG. 3 is an elevation view of one example of an embodiment of this invention wherein the source of light beam is angularly offset; and

FIG. 4 is a perspective view of one example of an embodiment of this invention in a linear optical encoder system.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

When the terms transparent or unblocked are used herein, it generally means that part or all of the light beam is allowed to pass through. This may also be referred to as transmissive as light is allowed to pass through, or is transmitted through the screen, When the terms opaque, blocked or non-transmissive are used, part or all of the light beam is blocked such that the optical sensor detects a low, second status, or a no light beam status. The raw signal generated in some embodiments of the invention may be a sine wave type of alternating signal as the disc rotates. Sometimes it is amplified and used as a sine wave but more typically it is digitized and made into a logic digital signal.

It will be appreciated by those of ordinary skill in the art that the term light beam may include any one of a number of signals which may be emitted or transmitted by any one of a number of different optical components, with a light emitting diode being the preferred in this disclosed embodiment of the invention. However, this invention is not limited to such a light beam, or it may also include without limitation any one of the following: optical signal, laser, incandescent light, LED, fiber optic cable and the like.

This invention may utilize different optical components for different elements of the invention, with no one in particular being required to practice the invention in a given embodiment. This may for example include elements such as light emitters, sensors and the opaque or transparent areas of the light interruption screen. Such optical components may include, without limitation, optical connectors, optical sensors, optical chips, optical ASIC's, charged coupled devices (“CCD's”), photo diodes, or others, all within the contemplation of this invention, with no one in particular being required to practice this invention.

A benefit from some embodiments of the invention may be the ease of installation. As one example in the rotational component aspect of this invention, the installers are typically required by prior art methods to position the light source or light emitter and the light sensor relative to the light interruption disc and then slide the entire configuration onto the shaft of the rotating component. Alternately, the light emitter and light sensor assembly may be slid in from the side at a plane ninety degrees from the axis of rotation in a rotational application.

The angling and placement of the light emitter in, this invention allows the installer to first install the light emitter and light detector with framework, and then after that to slide or place the fitting of the light interruption screen over the shaft or rotating member. It will also be appreciated by those of ordinary skill in the art that unlike some prior art configurations (wherein for instance the disc or screen must be slid into a slot first and then the module then slid over the rotating shaft, or alternatively the disc must first be installed to the rotating member and then the module slid into position from the side), this invention does not provide a slot into which the rotating disc or screen for instance must be confined.

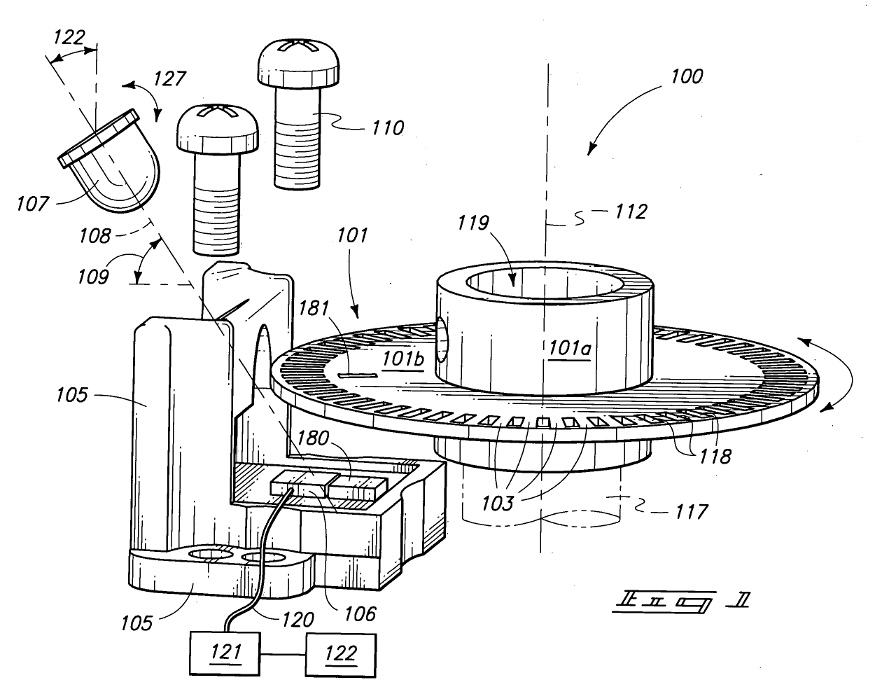

FIG. 1 is a perspective exploded view of one example of an embodiment of an encoder system 100 contemplated by this invention, illustrating optical encoder framework 105 with optical sensor 106 positioned relative to optical encoder framework 105. The light or optical sensor 106 may be an optical detector or any one of a number of other optical components for receiving a light beam for further processing of the data. Light source or light emitter 107 is shown positioned relative to optical encoder framework 105 such that light beam 108 is emitted at an angle relative to the optical sensor 106 or detector, and relative to the axis 112 of rotation. The first angle 122 is shown relative to vertical which would also be relative to axis 112 of rotatable member 101. The light emitter 107 emits a light beam line 108 at angle 109 relative to an angle perpendicular to the rotational axis 112.

The light interruption screen 101 in this embodiment is a rotating disc and includes a fitting 101 with an internal aperture 119 to receive a rotating component to be monitored such as a motor shaft. The fitting portion 101a may be integral with the screen portion 101b, or two components operably attached. An exemplary shaft 117 is show in Figure 1.

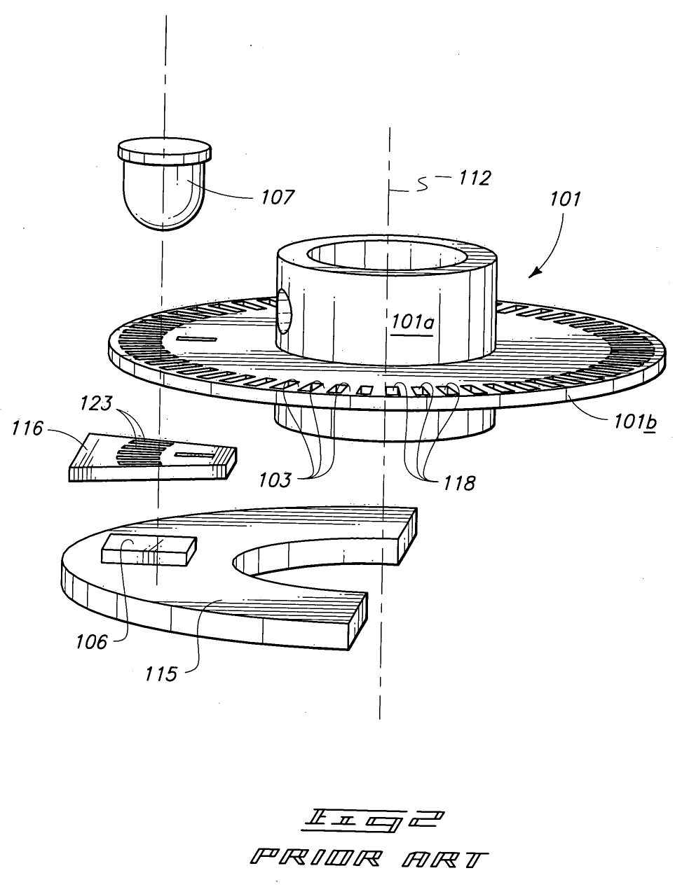

The light interruption screen includes transparent areas 118 and opaque areas 103. Rotational axis 112 of rotatable member 101 would typically be the same axis as for the shaft 117. Prior art encoders typically transmit a light beam substantially parallel to the axis 112, as shown in FIG. 2.

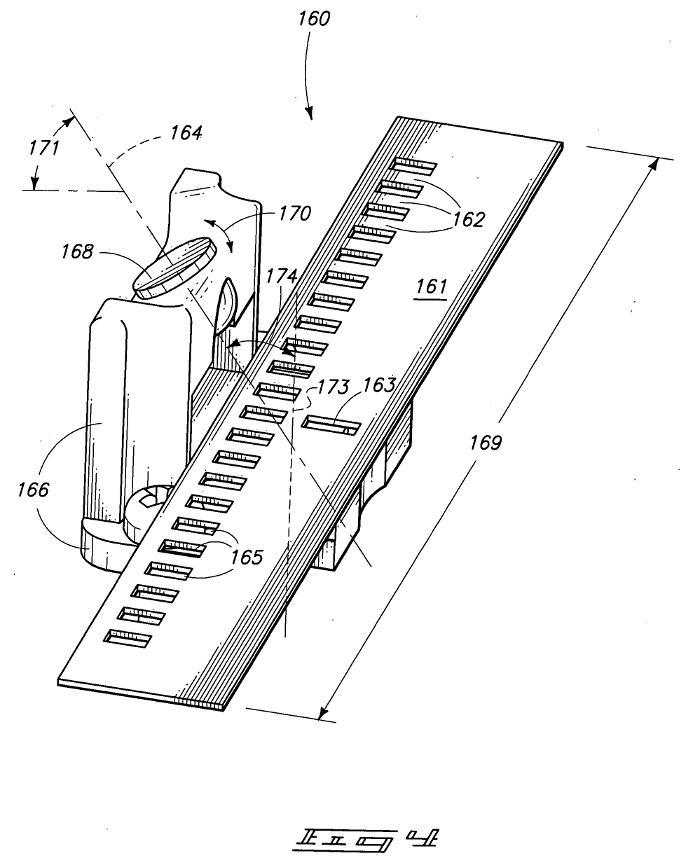

It will be appreciated by those of ordinary skill in the art that one aspect of an optical encoder configured for rotational components, in which embodiment the encoder detects angular movement between first and second members that rotate relative to each other about a rotational axis. In other embodiments, the encoder is adapted for monitoring the linear movement of a component being monitored or measured, as shown in FIG. 4.

The positioning of the light emitter at an angle allows the light emitter 107 to be mounted other than vertical to rotatable member 101. This allows the light emitter 107 to be positioned relative to optical encoder framework 105 and light detector 106 and mounted on a device such as a motor prior to positioning a rotatable member 101 relative to optical encoder framework 105.

It will be appreciated by those of ordinary skill in the art that in, a first aspect as generally shown in the figures, an encoder system for detecting angular movement between the first member and a second member (which may be one member rotating relative to another or there may be linear movement between the respective members) generally relative to an axis (which may be a rotational axis). If it is an optical encoder system, the rotatable members would include a signal interrupting screen often referred to as disk that is mounted to a fitting secured to and defined as a rotational axis of the encoder. Rotational member 101 may include fitting portion 101a which may be attached to a rotating shaft, for instance.

In FIG. 1 for example the light emitter 107 is positioned at a substantial angle so that the light beam 108 is projected at an angle through the light beam interrupting disk to the light sensor 106 positioned on the opposite side of the disk portion 101b of rotating member 101. Light emitter 107 may also be configured such that the angle is adjustable such as shown by arrow 127. Screws 110 may be utilized to fix the framework 105 relative to the device or component being monitored with the invention.

FIG. 1 also shows that light sensor 106 is electrically connected in this example by conductor 120 to signal converter 121 for further transmission to electronic component 122 for control or other desired functions. The light sensor 106 may include a signal converter to convert the interrupted light into an electrical signal, or it may be in a separate electronic device, all within the contemplation of this invention with the schematic depiction thereof in FIG. 1 being representative and schematic only, and not limiting of the invention. It will be appreciated by those of ordinary skill in the art that any one of a number of different devices may be utilized to convert the interrupted light received into one or more electrical signals. As one example of a known way, custom ASIC's may be utilized to generate a sine wave, which is then converted to a square wave signal and transmitted to a counter for further processing.

FIG. 1 also illustrates that more than one light sensor may be utilized, depending on the application of the specific embodiment, with second light detector 180 being shown and positioned in this embodiment to receive light (a reference pulse for example) through the single slit 181.

FIG. 1 further shows schematically how additional components may be operationally connected to the light sensors to receive electrical signals or other information directly or indirectly from the light sensor 106. The first electrical component 121 and second electrical component 122 may therefore be any one of a number of different types of components, with no one in particular being required to practice the invention. There may be signal conditioners, controllers, displays, motor feedback circuits, signal manipulators or other devices comprising the first and/or second electrical components 121 and 122. Furthermore while the first electrical component 121 is shown in FIG. 1 hard-wired to the light sensor 106, this is representative only and instead the two components may be all incorporated into the same ASIC device, circuit board or other nano device.

FIG. 2 is a perspective exploded view illustrating the components of an encoder module which is configured in a prior art configuration wherein the source of the optical signal is generally aligned such that the light emitter 107 emits light substantially parallel to the rotational axis 112. FIG. 2 illustrates light emitter 107, light interruption screen 101 with opaque regions 103 and transparent regions 118 on the disc portion 101b of the light interruption screen 101. A reticle 116 is shown between the light emitter 107 and the light sensor 106, and a portion of the framework 115, the reticle including transparent areas 123.

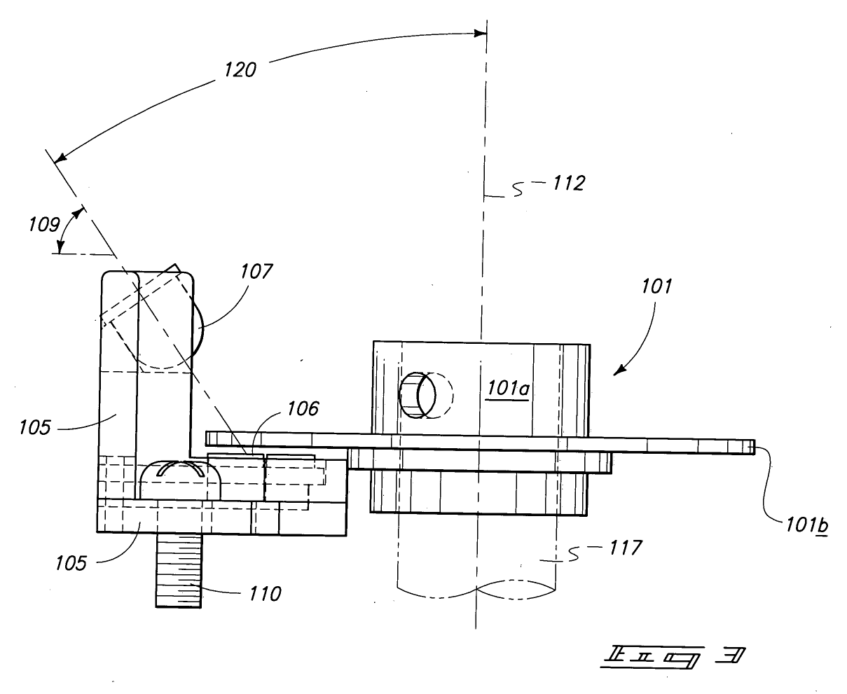

FIG. 3 is an elevation view of one example of an embodiment of this invention wherein the source of light beam is angularly offset from the rotational axis 112 and mounted outside of the perimeter or outer perimeter of light interruption screen 101b. The light interruption screen 101b is operatively attached to fitting 101a, and fitting 101a adapts the light interruption screen 101b to a rotating component such as shaft 117. In the aspect of this invention directed to rotating members, the outer perimeter of the light interruption screen 101b, may, but need not be, a circle which would therefore have a radius. The advantage of the light source or light emitter 107 being mounted outside the perimeter of the light interruption screen 101b is that the light emitter 107 can be mounted or operatively attached to the encoder framework 105 before the light interruption screen 101b is positioned relative to the light emitter 10,7 and the light sensor 106.

FIG. 3 further illustrates screw 110, angle 120 between the angle the light emitter emits the light beam and the axis 112 of rotation, as well as angle 109, which is the angle between the direction the light emitter emits the light beam and a line perpendicular to the axis 112 of rotation.

It will be appreciated by those of ordinary skill in the art that the object being monitored by the encoder system may be at any orientation and the fact that the drawings herein show the axis 112 of rotation in a vertical orientation does not mean the system is not anticipated to be mounted at any one of a number of different angles, with no one in particular being required to practice this invention. In rotating shaft applications for instance, the encoder system may be mounted to a motor and shaft in whatever orientation the motor or shaft is configured. In other aspects of the invention, the light sensor may be placed vertically above the disk and the light emitter below the disc, all within the contemplation of this invention, with no particular configuration being required to practice any embodiment of the invention.

FIG. 4 is a perspective view of one example of an embodiment of this invention in a linear optical encoder system 160 used on linear moving object 161 which has a finite length 169 in this example of this embodiment. FIG. 4 illustrates one or more transparent regions 165, aperture 163 and one or more opaque regions 162, in light interruption screen 161, for linear motion applications.

The light interruption screen 161 shown in FIG. 4 further illustrates an outer perimeter and a vertical axis 173 which is perpendicular to the face of the light interruption screen 161. The light emitter 168 in the embodiment of the invention shown in FIG. 4 is shown mounted to framework 166 outside of the perimeter or outer perimeter of the light interruption screen 161, and at an angle 174 greater than ten degrees relative to generally perpendicular to the light interruption screen 161, with line 164 indicating the line or path of the light emitted. It will be appreciated by those of ordinary skill in the art that while it may be preferred in some embodiments to place the light emitter 168 outside the perimeter of the light interruption screen 161, it is not required to practice this invention. The light is emitted at angle 171 relative to a plane generally parallel to light interruption screen 161. A light sensor is located below the light interruption screen 161, although not shown in this figure. Arrow 170 illustrates that light emitter 168 may be adjustably or rotatably mounted relative to framework 166 to allow for changes to angle 171.

It will be appreciated by those of ordinary skill in the art that the light sensor in any of the embodiments of this invention may be any one of a number of different light sensors, or a combination of more than one sensor, all within the contemplation of this invention and generally known to those of ordinary skill in the art, with no one in particular being required to practice the invention.

Some aspects of this invention also include a novel method for the assembly of optical encoders for use such that the light emitters and light sensors can be operatively calibrated, connected, or disposed relative to the framework and then installed on the object or device before the light interruption screen is mounted relative to the framework, to detect mechanical movement. In some embodiments and applications, this may provide a time and expense savings in the installation. One such method for assembling an optical encoder for example may include the following: providing an encoder framework; providing a light source for emitting light, said light source mounted to the encoder framework; providing a light detector attached to the encoder framework and disposed to receive light emitted from the light source; fixing the optical encoder relative to a movable subject component; providing a light interruption screen with one or more opaque regions and one or more transparent regions, and further a fitting configured for operational attachment to a movable subject component; and then attaching the fitting of the light interruption screen to a rotatable shaft such that the one or more opaque regions and the one or more transparent regions are positioned between the light source and the light detector, such that movement of the one or more opaque regions of the light interruption screen interrupts the light emitted from the light source to the light detector.

In yet another embodiment of the invention, an optical encoder for application on a rotational component is provided, wherein the optical encoder comprises: an encoder framework; a light emitting means for emitting light, said light emitting means being mounted to the encoder framework; a light detection means attached to the encoder framework and disposed to receive light emitted from the light emitting means; a light interruption means with one or more opaque regions and one or more transparent regions, the one or more opaque regions and one or more transparent regions being movably positioned between the light emitting means and the light detection means such that movement of the one or more opaque regions of the light interruption screen interrupts the light emitted from the light emitting means to the light detection means; wherein the light interruption means further includes a means for adapting the light interruption means to a rotating object, wherein the means for adapting the light interruption means has a rotational axis; and further wherein the light emitting means is mounted to the encoder framework so as to emit the light at an angle at least ten degrees offset from the rotational axis.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. An optical encoder for use with a rotational component, comprising: an encoder framework;
a light source for emitting light, said light source mounted to the encoder framework;
a light detector attached to the encoder framework and disposed to receive light emitted from the light source;
a light interruption screen with one or more opaque regions and one or more transparent regions, the one or more opaque regions and one or more transparent regions being movably positioned between the light source and the light detector such that movement of the one or more opaque regions of the light interruption screen interrupts the light emitted from the light source to the light detector;
wherein the light interruption screen is configured for operational attachment to a rotating object; and
further wherein the light source is mounted to the encoder framework so as to emit the light at an angle at least ten degrees offset from the rotational axis.

2. An optical encoder as recited in claim 1, and further wherein the light interruption screen is operationally integral with a fitting, and the fitting is configured for attachment to a rotatable shaft.

3. An optical encoder as recited in claim 1, and further comprising a light converter operationally combine with the light detector to convert the interrupted light into at least one electrical signal.

4. An optical encoder as recited in claim 1, and further wherein the light interruption screen has an outer perimeter and the light emitter is disposed transverse to and outside of the outer perimeter of the light interruption screen.

5. An optical encoder as recited in claim 1, and further wherein the light source is mounted to the encoder framework so as to emit the light at an angle at least twenty degrees offset from the rotational axis.

6. An optical encoder as recited in claim 1, and further wherein the light source is mounted to the encoder framework so as to emit the light at an angle at least thirty degrees offset from the rotational axis.

7. An optical encoder for detecting linear movement between first and second member that move in a linear manner relative to each other, comprising:
an encoder framework;
a light source for emitting light, said light source mounted to the encoder framework;
a light detector attached to the encoder framework and disposed to receive light emitted from the light source;
a light interruption screen operationally attached to an object which moves linearly, the light interruption screen including one or more opaque regions and one or more transparent regions, the one or more opaque regions and one or more transparent regions being movably positioned between the light source and the light detector such that movement of the one or more opaque regions of, the light interruption screen interrupts the light emitted from the light source to the light detector; and
further wherein the light source is mounted to the encoder framework so as to emit the light at an angle at least ten degrees offset from an axis perpendicular to the light interruption screen.

8. An optical encoder as recited in claim 7, and further wherein the light interruption screen has an outer perimeter and the light emitter is disposed transversely outside of the outer perimeter of the light interruption screen.

9. An optical encoder as recited in claim 7, and further wherein the light source is mounted to the encoder framework so as to emit the light at an angle at least twenty degrees offset from a perpendicular axis of the light interruption screen.

10. An optical encoder as recited in claim 7, and further wherein the light source is mounted to the encoder framework so as to emit the light at an angle at least thirty degrees offset from a perpendicular axis of the light interruption screen.

11. An optical encoder for application on a rotational component, comprising:
an encoder framework;
a light emitting means for emitting light, said light emitting means being mounted to the encoder framework;
a light detection means attached to the encoder framework and disposed to receive light emitted from the light emitting means;
a light interruption means with one or more opaque regions and one or more transparent regions, the one or more opaque regions and one or more transparent regions being movably positioned between the light emitting means and the light detection means such that movement of the one or more opaque regions of the light interruption screen interrupts the light emitted from the light emitting means to the light detection means;
wherein the light interruption means further includes a means for adapting the light interruption means to a rotating component, wherein the means for adapting the light interruption means has a rotational axis; and
further wherein the light emitting means is mounted to the encoder framework so as to emit the light at an angle at least ten degrees offset from the rotational axis.

12. A method for assembling an optical encoder comprising the following:
providing an encoder framework;
providing a light source for emitting light, said light source mounted to the encoder framework;
providing a light detector attached to the encoder framework and disposed to receive light emitted from the light source;
fixing the optical encoder relative to a movable subject component;
providing a light interruption screen with one or more opaque regions and one or more transparent regions, and further a fitting configured for operational attachment to a movable subject component; and then
attaching the fitting of the light interruption screen to a rotatable shaft such that the one or more opaque regions and the one or more transparent regions are positioned between the light source and the light detector, such that movement of the one or more opaque regions of the light interruption screen interrupts the light emitted from the light source to the light detector.

13. A method as recited in claim 12, and further wherein the light interruption screen has an outer perimeter and the light source is disposed transversely outside of the outer perimeter of the light interruption screen.
